(19) United States
(12) Patent Application Publication
(10) Pub. No.: US 2015/0071452 A1
(43) Pub. Date: Mar. 12, 2015

(54) ACTIVE SOUND GENERATION DEVICE

(71) Applicant: FRIEDRICH BOYSEN GMBH & CO. KG, Altensteig (DE)

(72) Inventors: Dominik FENCHEL, Neuweiler-Breitenberg (DE); Roland GAUSS, Simmersfeld-Oberweiler (DE); Michael HERBIG, Freudenstadt (DE); Stefan MAX, Altensteig (DE); Matthias OESTERELE, Pfalzgrafenweiler (DE); Ramazan SAHAN, Pfalzgrafenweiler (DE)

(21) Appl. No.: 14/472,289

(22) Filed: Aug. 28, 2014

(30) Foreign Application Priority Data
Sep. 6, 2013 (DE) 102013217849.2

(51) Int. Cl. F01N 1/06; G10K 11/16; F01N 13/08

(52) U.S. Cl. CPC F01N 1/065; F01N 13/08; G10K 11/16
USPC 381/71.5

(57) ABSTRACT

An active sound generation device for exhaust gas systems of motor vehicles having a housing and a sound generation means arranged in the housing, in particular a loudspeaker, with a closed sound generation surface and a margin sealingly surrounding the sound generation surface, wherein, for the reduction of the manufacturing costs, the housing has an at least sectionally cylindrical shape and the inner diameter of the cylindrical shape corresponds to the projection of the outer periphery of the margin surrounding the sound generation surface onto a surface perpendicular to the cylinder axis such that the sound generation means can be inserted in a gas-tight manner at any desired point of the cylindrical section.

The present invention relates to a sound generation device for exhaust gas systems of motor vehicles having a housing and a sound generating means, in particular a loudspeaker, arranged in the housing with a closed sound generation surface and a margin tightly enclosing the noise generation surface.

The generation of sound or anti-sound or of other sounds for the acoustic influencing of engine sound requires inter alia an exact configuration of the front volume and rear volume of the activator housing which have to be comparatively large, at least with internal combustion engines, to achieve a sufficient sound absorption or sound influencing by modulating the engine sound. Since each engine type has a different characteristic with respect to the generated sound pressure level and since elements connected to the engine can also have an acoustic effect, the acoustic effect of the active sound generation system has to be configured separately for each motorization.

It is the underlying object of the invention to meet these demands.

This object is satisfied by the independent claims. The dependent claims relate to advantageous further developments of the invention.

In accordance with claim 1, the object is in particular satisfied in that the housing has an at least sectionally cylindrical shape and in that the inner diameter of the cylindrical shape corresponds to the projection of the outer periphery of the margin surrounding the sound generation system onto a surface perpendicular to the cylinder axis such that the sound generation means can be inserted in a gas-tight manner at any desired point of the cylindrical section.

The ratio of front volume and rear volume of the sound generation device can be varied by the possibility of arranging the sound generation means at any desired point of the cylindrical section. It is thereby possible to use one and the same housing for different motorizations. Costs are thus saved. The gas-tightness can be achieved, for example, by welding or brazing the margin to the cylindrical section. It effects the separation of the front volume and rear volume, that is of the housing volume before and behind the sound generation surface. The housing can, for example, comprise shells or can be configured as a wrap housing.

The housing preferably has a middle cylindrical section which is closed at both sides by arched termination walls which are preferably formed as identical parts. This housing shape has proved to be particularly advantageous, with the use of identical parts further lowering the costs.

The outer periphery of the margin of the sound generation means can be at least approximately circular, oval or elliptical. The housing can advantageously be configured as flatter in one direction by ab oval or elliptical shape. The small construction space beneath a vehicle floor can thus be taken into account.

An adapter ring is preferably provided which forms at least the outermost part of the margin of the sound generation means. The adapter ring can be releasably or non-releasably connected to the sound generation surface. It allows a good adaptation of the sound generation means to the housing shape independently of the outer periphery of the sound generation surface. The adapter ring can be fixedly connected to the housing, for example by welding.

In accordance with a further embodiment of the invention, the sound generation surface can be inclined in at least one direction with respect to the longitudinal axis of the cylindrical section of the housing. The construction space of the housing can thus be further reduced with the same sound output surface of the sound generation means.

In accordance with the second independent claim, the housing is formed by two half-shells, with the sound generation surface extending transversely or inclined with respect to the separation plane of the two half-shells. An inexpensive construction of the housing hereby results.

The sound generation surface preferably passes through the separation plane of the two half-shells. A good utilization of the construction space thereby results together with the possibility of selecting the front volume and rear volume of the actuator housing in a suitable manner. It is further preferred if the margin of the sound generation surface is connected to both half-shells, in particular directly or in particular not via the respective other half-shell. The volume of the actuator housing is thereby divided into a front volume and rear volume substantially transversely to the separation plane.

In accordance with an embodiment of the invention, the sound generation means can be clamped between the two half-shells, in particular by means of a bead running around both half-shells. The manufacturing costs can thereby be further reduced. Sealing material is preferably inserted into the bead for the separation of the front volume and the rear volume. The sound generation means can, however, also be connected in a gas-tight manner to the two half-shells in another manner, for example by welding or brazing.

In accordance with another embodiment of the invention, the sound generation means is screwed to a first flange provided at one half-shell, whereas a second flange is provided at the other half-shell which contacts the sound generation means in the assembled state of the half-shells and surrounds said sound generation means together with the first flange in a gas-tight manner to form a rear volume and a front volume. An inexpensive construction also hereby results.

In accordance with yet another embodiment of the invention, the sound generation means is connected to a half-shell by means of a clip, whereas the margin of the sound generation means is connected to the half-shells in a gas-tight manner by welding to form a front volume and a rear volume. This construction is also inexpensive.

In accordance with a further embodiment of the invention, the sound generation means, in particular the magnet of a loudspeaker, is additionally supported with respect to the housing via at least one further device, in particular a ferromagnetic or paramagnetic bracket. A more stable construction thereby results. The additional device can be connected to the loudspeaker magnet purely magnetically due to the use of a ferromagnetic or paramagnetic bracket, whereby separate connection elements can be saved.

The further device for supporting the sound generation means can also be configured for leading heat off from the sound generation means to the housing. An overheating of the sound generation means can thus be avoided.

In accordance with a further embodiment of the invention, the housing has a receiver for at least a part of the magnet of a loudspeaker. In this respect, can also only be a wall section of the housing which the magnet contacts. A further support of the sound generation means is produced via this receiver, whereby the stability of the construction is further increased.

In accordance with a further embodiment of the invention, a pipe is provided which conducts the generated sound out of the housing and to a sound superimposition location. In this respect, the pipe can preferably be bent at least once. The thermal separation of the housing from the exhaust gas system is thus improved, on the one hand, and larger objects cannot penetrate into the housing so easily, on the other hand. Another possibility of avoiding a penetration of objects into the housing comprises a barrier, for example a mixer or another slightly gas permeable element such as a grid or the like which is installed in the pipe.

The thermal separation from the exhaust gas system can in turn be improved by a particularly long pipe. Another possibility comprises making the pipe short and connecting it to the exhaust gas system via a thermally insulated connection. A mechanical decoupling between the housing and the exhaust gas system by a so-called decoupling element, for example by a bellows in the exhaust pipe, is likewise advantageous.

In accordance with a particular embodiment of the invention, the active sound generation device can be connected to the exhaust gas system via a double opening. In this case, a pipe connection is preferably provided between the two parts of the double opening and a sensor for measuring the pressure difference between the two parts is arranged in said pipe connection. The superimposition of engine sound and generated sound, for example disturbing noise and anti-sound, can thus be measured by only one sensor and can be used for the regulation of the active sound absorption device.

The housing can moreover be provided with an outlet opening which opens to the outside or with a suction pipe for condensed water. The suction pipe is in this respect connected at its second end to an exhaust pipe of the exhaust gas system. Condensed water is sucked out of the housing via the suction pipe due to the pressure difference between the exhaust gas system and the housing.

Embodiments of the invention are shown in the drawings and will be described in the following. There are shown, schematically in each case

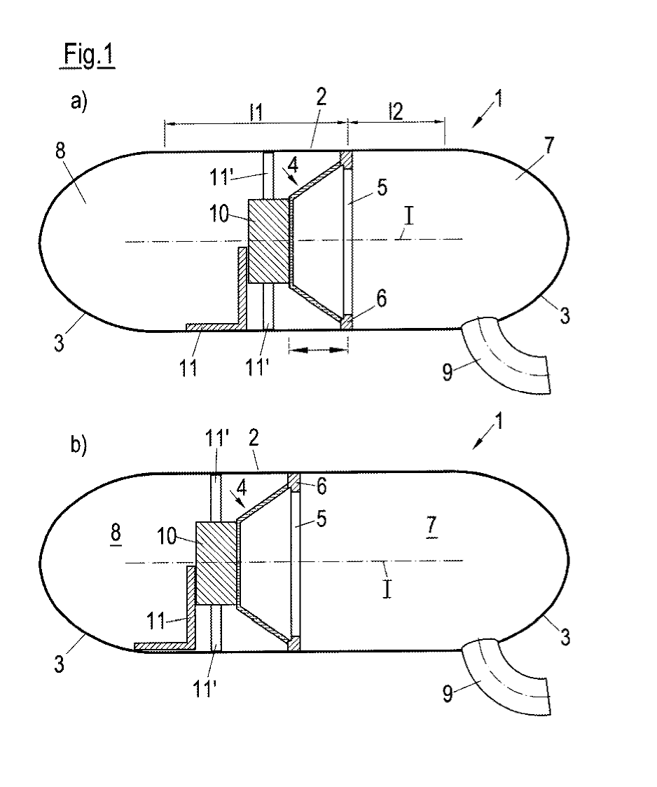

FIGS. 1a and b a first embodiment of the invention with two different installation positions;

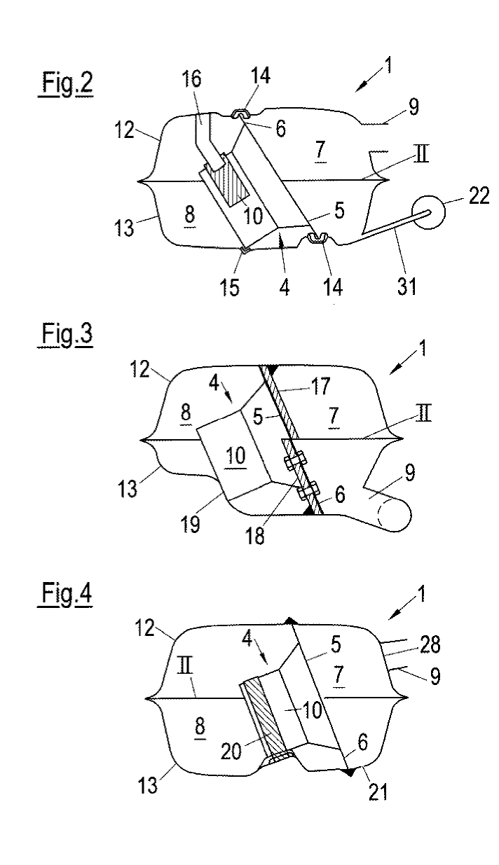

FIG. 2 a second embodiment of the invention with a housing comprising two half-shells;

FIG. 3 a variant of FIG. 2;

FIG. 4 a further variant of FIG. 2;

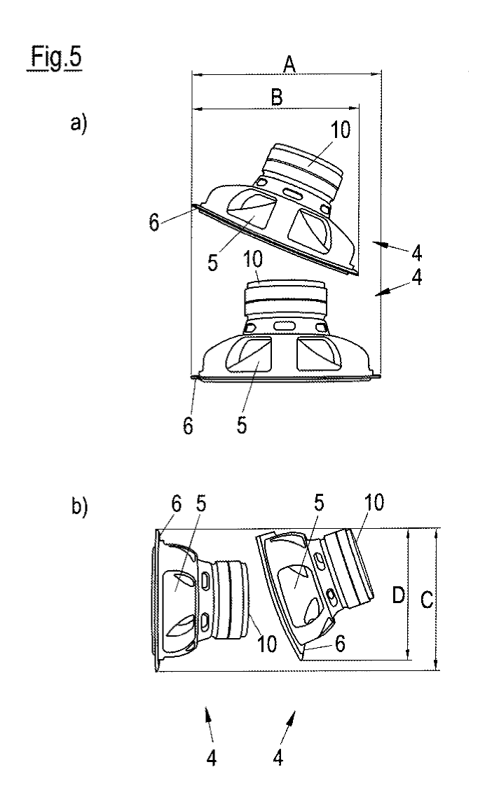

FIGS. 5a and b different inclination possibilities of a loudspeaker in a housing;

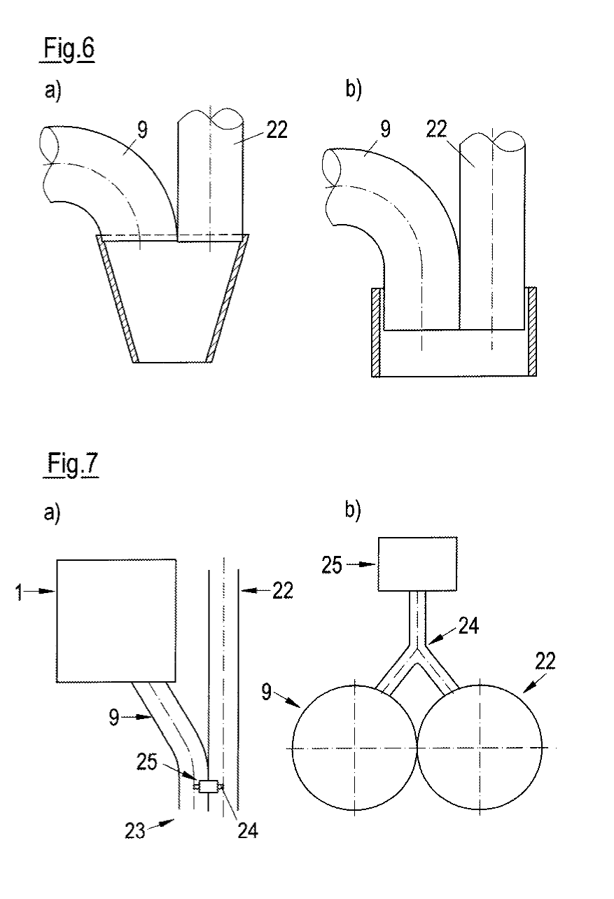

FIGS. 6a and b two combining possibilities for the pipe led out of the housing and an exhaust pipe of the exhaust gas system;

FIGS. 7a and 7b a double-opening section with a pipe connection and a sensor in a plan view and in cross-section; and

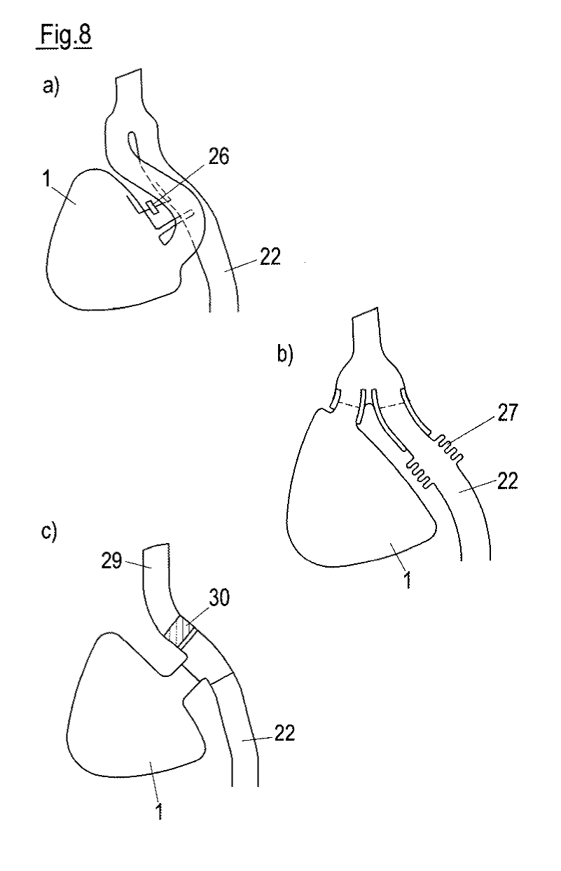

FIGS. 8a to c three further combinations between the active sound absorber and the exhaust gas system.

The sound generation device shown in FIG. 1 comprises a housing 1 with a middle cylindrical section 2 and two arched termination walls 3 which are arranged at both sides thereof and which are formed as identical parts. A loudspeaker 4, whose membrane 5 forms a sound generation surface, is arranged in the housing 1. The membrane 5 is radially outwardly surrounded by an adapter ring 6 which is fixedly connected, in particular welded, to the housing 1 and which is formed in a gas-tight manner with respect to the membrane 5. In this manner, the inner space of the housing 1 is divided by the loudspeaker 4 and the adapter ring 6 into a front volume 7 and a rear volume 8. The ratio of front volume and rear volume can be set as required by displacing the loudspeaker 4 along the cylindrical section 2 in accordance with the double arrow.

A reflex tube 9 which is formed as curved is led out of the front volume 7. A penetration of objects into the housing 1 is made difficult thereby. Furthermore, the magnet 10 of the loudspeaker 4 is additionally supported with respect to the housing 1 via a bracket 11. The bracket 11 is ferromagnetic or paramagnetic so that no additional fastening is required. Alternatively or additionally, cross-struts 11′ can be provided between the loudspeaker magnet 10 and the housing 1.

The cross-section of the loudspeaker membrane 5 and of the adapter ring 6 as well as the cylindrical section 2 of the housing 1 can in particular be circular, oval or elliptical. The height can thus be reduced with respect to the width of the housing 1. Furthermore, as shown in FIGS. 5a and 5b, the loudspeaker can be inclined in one or two mutually perpendicular directions with respect to the longitudinal axis I of the cylindrical section 2. This results in each case in a reduced cross-section of the housing 1 with an unchanged sound output surface, as results from a comparison of the dimensions A, B or C, D.

In the variants of the invention shown in FIGS. 2 to 4, the housing comprises two half-shells, namely an upper shell 12 and a lower shell 13. In the variant shown in FIG. 2, the loudspeaker 4 is clamped between the two half-shells by means of a bead 14 running around over the upper shell 12 and the lower shell 13. The loudspeaker 4 is additionally supported via a further bead 15 in the lower shell 13. A further support is provided via a ferritic holder 16.

In the variant shown in FIG. 3, a respective flange 17, 18 is provided in the upper shell 12 and the lower shell 13 respectively. The loudspeaker 4 is screwed to the flange 18 of the lower arm 13 via its peripheral margin 6, with the flange being arranged on the rear side of the margin 6. The flange 17 of the upper shell 12 contacts the margin 6 of the loudspeaker 4 from the front with an assembled housing 1 and forms, together with the flange 18, a gas-tight seal of the loudspeaker 4 with respect to the housing 1. The magnet 10 of the loudspeaker 4 moreover contacts a support surface 19 of the lower shell 13. The reflex tube 9 is led out of the housing 1 with a slope, which is also advantageous in all other embodiments of the invention.

In the variant shown in FIG. 4, the loudspeaker 4 is connected via a clip 20 to the lower shell 13. The margin 6 of the loudspeaker 4 is connected in a gas-tight manner to the upper shell 12 and to the lower shell 13 by laser welding. The lower shell 13 moreover has a hole 21 for the draining of condensed water. Instead of a hole, a suction pipe 31, as shown in FIG. 2, can also be provided for sucking off condensed water, the suction pipe being connected at its other end to an exhaust pipe 22 of the exhaust gas system. Both variants can be used in all embodiments of the invention.

FIG. 6 shows the combination of a reflex tube 9 of a sound generation device in accordance with the invention with an exhaust pipe 22 of an exhaust gas system. In FIG. 6a, the combination is configured in funnel shape, whereas it is cylindrical in FIG. 6b. The combination can itself form the opening of the exhaust gas system or can be connected to a separate opening via a pipe.

FIG. 7 shows a double opening 23 of a reflex tube 9 of a sound generation device in accordance with the invention and of an exhaust pipe 22 of an exhaust gas system. The two pipes 9, 22 are connected to one another via a pipe connection 24. The pressure difference between the reflex tube 9 and the exhaust pipe 22 can be determined via a sensor 25 in the pipe connection 24 and can be used for the regulation of the anti-sound generation. Alternatively, a sensor can respectively also be provided in the reflex tube 9 and in the exhaust pipe 22.

FIG. 8a shows another combination of an active sound generation device in accordance with the invention and of an exhaust pipe 22. As can be seen, the reflex pipe 9 is curved a multiple of times and is combined with the exhaust pipe 22. The active sound generation device is additionally supported with respect to the exhaust gas system via a rubber pendulum bearing.

The reflex tube 9 is short in the variant of a combination of a sound generation device in accordance with the invention shown in FIG. 8b with the exhaust pipe of an exhaust gas system. The combination is configured with air-gap insulation for the thermal decoupling of the active sound generation device from the exhaust gas system. Furthermore, a decoupling element 27 in the form of a bellows section is provided for the mechanical decoupling of the active sound generation device from the exhaust gas system. A grid 28 which prevents a penetration of objects can be provided between the reflex tube 9 and the housing 1 (see FIG. 4).

In the variant shown in FIG. 8b, the opening of the reflex pipe 9 into the exhaust pipe 22 likewise has air gap insulation. A mixer 30 which prevents a penetration of objects is arranged in the continuing exhaust pipe 29.

### REFERENCE NUMERAL LIST

1 housing
2 cylindrical section
3 termination wall
4 loudspeaker
5 loudspeaker membrane
6 adapter ring
7 front volume
8 back volume
9 reflex tube
10 loudspeaker magnet
11 bracket
11′ cross-strut
12 upper shell
13 lower shell
14 bead
15 bead
16 holder
17 flange
18 flange
19 support surface
20 clip
21 hole
22 exhaust pipe
23 double opening
24 connection pipe
25 sensor
26 rubber pendulum bearing
27 decoupling element
28 grid
29 continuing exhaust pipe
30 mixer
31 suction pipe
I longitudinal axis of 2
II separation plane

What is claimed is:

1. An active sound generation device for exhaust gas systems of motor vehicles having a housing and a sound generating means arranged in the housing with a closed sound generation surface and a margin sealingly enclosing the sound generation surface,
wherein the housing has an at least sectionally cylindrical shape; and
wherein the inner diameter of the cylindrical shape corresponds to the projection of the outer periphery of the margin surrounding the sound generation surface onto a surface perpendicular to the cylinder axis such that the sound generation means can be inserted in a gas-tight manner at any desired point of the cylindrical section.

2. The sound generation device in accordance with claim 1,
wherein the housing has a middle cylindrical section which is closed by arched terminal walls at both sides.

3. The sound generation device in accordance with claim 1,
wherein the terminal walls are formed as identical parts.

4. The sound generation device in accordance with claim 1,
wherein the outer periphery of the margin is at least approximately circular, oval or elliptical.

5. The sound generation device in accordance with claim 1,
wherein at least the outermost part of the margin is formed by an adapter ring which is connected releasably or non-releasably to the sound generation device.

6. The sound generation device in accordance with claim 5,
wherein the adapter ring is fixedly connected to the housing.

7. The sound generation device in accordance with claim 1,
wherein the sound generation device is inclined in at least one direction with respect to the longitudinal axis of the cylindrical section.

8. The sound generation device in accordance with claim 1,
wherein the sound generation means is supported, in addition to the peripheral margin, via at least one further device with respect to the housing.

9. The sound generation device in accordance with claim 8,
wherein a ferromagnetic or paramagnetic bracket is provided for the additional support.

10. The sound generation device in accordance with claim 8,
wherein the further device is configured for leading off heat from the sound generation means to the housing.

11. The sound generation device in accordance with 1,
wherein the housing has a receiver for at least a part of the magnet of a loudspeaker.

12. The sound generation device in accordance with claim 1,
wherein a tube is provided which conducts the generated sound from the housing and to a shell superimposition location.

13. The sound generation device in accordance with claim 12,
wherein the tube is bent at least once.

14. The sound generation device in accordance with claim 12,
wherein the pipe is provided with a barrier against the penetration of objects.

15. The sound generation device in accordance with claim 12,
wherein the pipe is particularly long.

16. The sound generation device in accordance with claim 12,
wherein the pipe is short and is connected to the exhaust gas system via a thermally insulated connection.

17. The sound generation device in accordance with claim 1,
wherein a decoupling element is provided for the mechanical decoupling of the active sound generation device from the exhaust gas system.

18. The sound generation device in accordance with claim 1,
wherein the sound generation device is connected to the exhaust gas system via a double opening; and wherein a pipe connection, in which a sensor is arranged for measuring the pressure difference between the two parts, is provided between the two parts of the double opening.

19. The sound generation device in accordance with claim 1,
wherein the housing is provided with an outlet opening opening to the outside or with a suction pipe for condensed water, with the suction pipe being connected at its second end to an exhaust pipe of the exhaust gas system.

20. An active sound generation device for exhaust gas systems of motor vehicles having a housing and a sound generation means arranged in the housing with a closed sound generation surface and a margin sealingly surrounding the sound generation surface, wherein the housing is formed by two half-shells,
wherein the sound generation surface extends transversely or inclined with respect to the separation plane of the two half-shells.

21. The active sound generation device in accordance with claim 20,
wherein the sound generation surface passes through the separation plane of the two half-shells.

22. The active sound generation device in accordance with claim 21,
wherein the margin of the sound generation surface is connected to both half-shells.

23. The active sound generation device in accordance with claim 22,
wherein the sound generation surface is directly connected to both half-shells.

24. The active sound generation device in accordance with claim 20,
wherein the sound generation means is clamped between the two half-shells.

25. The active sound generation device in accordance with claim 24,
wherein the sound generation means is clamped between the two half-shells by means of a bead running around over both half-shells.

26. The active sound generation device in accordance with claim 20,
wherein the sound generation means is screwed to a first flange provided at a shell; and wherein a second flange is provided at the other shell which contacts the sound generation means in the assembled state of the half-shells and surrounds it, together with the first flange, in a gas-tight manner.

27. The active sound generation device in accordance with claim 20,
wherein the sound generation means is connected to a half-shell by means of a clip; and wherein the margin of the sound generation means is connected in a gas-tight manner to the half-shells by welding.

28. The active sound generation device in accordance with claim 20,
wherein the sound generation means is supported, in addition to the peripheral margin, via at least one further device with respect to the housing.

29. The active sound generation device in accordance with claim 28,
wherein a ferromagnetic or paramagnetic bracket is provided for the additional support.

30. The active sound generation device in accordance with claim 28,
wherein the further device is configured for leading off heat from the sound generation means to the housing.

31. The active sound generation device in accordance with claim 20,
wherein the housing has a receiver for at least a part of the magnet of a loudspeaker.

32. The active sound generation device in accordance with claim 20,
wherein a tube is provided which conducts the generated sound from the housing and to a shell superimposition location.

33. The active sound generation device in accordance with claim 32,
wherein the tube is bent at least once.

34. The active sound generation device in accordance with claim 32,
wherein the pipe is provided with a barrier against the penetration of objects.

35. The active sound generation device in accordance with claim 32,
wherein the pipe is particularly long.

36. The active sound generation device in accordance with claim 32,
wherein the pipe is short and is connected to the exhaust gas system via a thermally insulated connection.

37. The active sound generation device in accordance with claim 20,
wherein a decoupling element is provided for the mechanical decoupling of the active sound generation device from the exhaust gas system.

38. The active sound generation device in accordance with claim 20,
wherein the active sound generation device is connected to the exhaust gas system via a double opening; and wherein a pipe connection, in which a sensor is arranged for measuring the pressure difference between the two parts, is provided between the two parts of the double opening.

39. The active sound generation device in accordance with claim 20,
wherein the housing is provided with an outlet opening opening to the outside or with a suction pipe for condensed water, with the suction pipe being connected at its second end to an exhaust pipe of the exhaust gas system.
